(19) United States
(12) Patent Application Publication
(10) Pub. No.: US 2026/0252640 A1
(43) Pub. Date: Aug. 27, 2026

(54) INTENT-CENTRIC SEARCH QUERY REFORMULATION

(71) Applicant: eBay Inc., San Jose, CA (US)

(72) Inventors: Jayanth Kumar YETUKURI, San Jose, CA (US); Ishita Kamal KHAN, San Jose, CA (US)

(21) Appl. No.: 19/296,127

(22) Filed: Aug. 11, 2025

Related U.S. Application Data
(60) Provisional application No. 63/763,474, filed on Feb. 26, 2025.

(51) Int. Cl. G06F 16/9532; G06F 16/9535

(52) U.S. Cl. CPC G06F 16/9532; G06F 16/9535

(57) ABSTRACT

Some aspects relate to technologies for intent-centric search query reformulation. In accordance with some aspects, a generative model is trained for query reformulation. User behavior data is accessed that includes session data for a number of user sessions, including a sequence of search queries for each user session. Query pairs are identified from the user behavior data, including in-session query pairs from in-session data and cross-session queries from cross-session data. The query pairs are labeled with search intent labels based on predefined search intents. A training dataset is generated in which each training sample comprises a labeled query pair. A generative model is then trained using the training dataset to provide a trained generative model that generates reformulated queries from input queries and search intents for the input queries.

### CROSS-REFERENCE TO RELATED APPLICATIONS

This patent application claims the benefit of U.S. Provisional Application No. 63/763,474, filed Feb. 26, 2025, which is herein incorporated by reference in its entirety.

### BACKGROUND

Listing platforms, such as e-commerce websites, are online platforms that offer products, services, digital content (e.g., music, videos, etc.), or other items to users. Such platforms typically offer a vast number of items. While some items are relevant to any given user, the majority is not. As a result, item retrieval for listing platforms is a particular Internet-centric problem that has proven to be difficult to fully address. That is, given a large number of items available on a listing platform, what items should be retrieved and presented to a user and in what order.

Given the vast number of items available, listing platforms include item retrieval functionality, such as search and recommendation, to assist users in finding items of interest on the platforms. For instance, listing platforms often provide search capabilities that receive search queries and return search results identifying items relevant to the search queries. Listing platforms also often leverage recommendation systems to recommend items that are likely of interest to users based on a variety of information, such as an item currently being viewed by a user, user attributes, and user behavior on the listing platforms (e.g., previous item views, purchases, etc.).

### SUMMARY

Some aspects of the present technology relate to, among other things, to intent-centric search query reformulation for item retrieval systems, which involves training a generative model to reformulate search queries based on search intent. This technology is designed to improve the accuracy and relevance of search results on listing platforms by understanding and reformulating search queries to better match their search intent.

In accordance with some aspects, training data is gathered by accessing user behavior data, which includes sequences of search queries received during various user sessions. The user behavior data also includes information about user interactions with item listings identified in search results for each search query. Query pairs are identified from this data, including in-session query pairs from the same session and cross-session query pairs from different sessions. These query pairs serve as proxies for query reformulations for model training. Each query pair is then labeled with a search intent label based on identifying a predefined search intent for each query pair. Each labeled query pair provides a training sample that includes a source query, a target query, and a search intent label

The training dataset is used to train the generative model. During training, the model parameters are updated based on the training samples. The process can involve, for instance, providing a source query and search intent label from a training sample to the generative model, generating an output query, and calculating a loss based on the difference between the output query and the target query from the training sample. The model parameters are adjusted to minimize this loss, ensuring that the generative model can accurately generate reformulated queries based on intent.

Once trained, the generative model is used to perform query reformulation for input search queries. When a search query is received, the context of the search query is determined, which can be based on the user's current session history and/or the search application. Based on this context, a search intent is selected from the predefined set of search intents. The search query and the selected search intent are provided to the trained generative model, which generates a reformulated query. This reformulated query can then be used for various search operations, such as providing query suggestions or retrieving search results, thereby enhancing the relevance and accuracy of the search outcomes.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram to illustrate examples of forming query pairs from user behavior data in accordance with some implementations of the present disclosure;

FIG. 3 is a block diagram showing an example overall operation for intent-centric query reformulation in accordance with some implementations of the present disclosure;

FIG. 4 is a flow diagram showing a method for training a generative model for intent-centric search query reformulation in accordance with some implementations of the present disclosure;

FIG. 5 is a flow diagram showing another method for training a generative model for intent-centric search query reformulation in accordance with some implementations of the present disclosure;

FIG. 6 is a flow diagram showing a method for obtaining a reformulated query and performing a search operation using the reformulated query in accordance with some implementations of the present disclosure; and

FIG. 7 is a block diagram of an exemplary computing environment suitable for use in implementations of the present disclosure.

### DETAILED DESCRIPTION

### Overview

Many listing platforms (e.g., e-commerce websites) offer a large number of item listings and also serve a large number of visitors. For instance, it has been reported that the eBay listing platform has 1.7 billion item listings, and the monthly number of visits to eBay websites has reached almost 3 billion. Each user visit to the website of a listing platform by a user involves servers of the listing platform processing user inputs and providing, over a network, digital content to a user device of the user as the user navigates the website. This can include, for instance, providing search result pages in response to search input, browse node pages in response to users browsing the website or navigation from external sources, and item pages when users select to view information for particular item listings.

Given the vast number of available item listings and user visits, listing platforms require significant server resources to ensure smooth performance and quick load times, even during peak traffic periods, as well as advanced database management systems to efficiently organize and retrieve item listing information. As a result, listing platforms demand extensive server processing and storage resources to handle the dynamic and high-demand environment effectively. Many listing platform providers attempt to design their server systems to provide relevant item listings to users as quickly and efficiently as possible in order to reduce the computing resource consumption required for the user visits. For instance, if the item retrieval system of the listing platform is ineffective in returning relevant search results, users will submit additional search queries until relevant search results are returned. These repetitive search queries can exponentially increase the computer resource consumption of the listing platform (e.g., increased bandwidth, memory, and CPU usage). Additionally, users often repeatedly select to view item pages for different item listings until they find relevant items. This requires the servers of the listing platform to repeatedly retrieve data from storage and provide the item pages to the user devices, also increasing computer resource consumption.

One search technique typically used by item retrieval systems is query reformation (sometimes referred to as query rewrite). Query reformulation is the process of modifying a search query to improve the retrieval of information. Conventional query reformulation approaches involve techniques such as adjusting or expanding the initial set of search terms based on the relevance of the search results obtained, the user's evolving information needs, or other factors. Common methods of query reformulation include adding synonyms, removing irrelevant terms, or specifying certain phrases to narrow or broaden the search scope.

While query reformulation is a useful tool for item retrieval systems, conventional query reformulation approaches face a number of technical challenges. One particular challenge is the ability of query reformulation techniques to accurately interpret received search queries in order to rewrite the queries to match the search intent. To address this challenge, some query reformulation approaches have been developed to better match search intent for specific search applications. However, these query reformulation approaches are specific to those search applications and do not generalize to other search applications.

Inaccurate query reformulations used by conventional item retrieval systems often result in the consumption of an unnecessary quantity of computing resources (e.g., I/O costs, network packet generation costs, throughput, memory consumption, etc.). For instance, poor query reformulations can result in low or even null results in some cases. The low and null results often require users to submit multiple queries before finding relevant item listings. On the other end of the spectrum, some query reformulations return a large number of item listings. If the query reformulation misses the intent of the search, the item listings returned may not be what the user is seeking, which typically requires users to submit multiple queries to refine the search results. For example, a user may issue a first query to a search engine of a listing platform that performs query reformulation in order to return a set of search results. The user may browse the search results and select certain search results to access the corresponding item listings. Selection of search results causes retrieval of the corresponding item listings. Additionally, in some cases, applications are launched in order to render data associated with the item listings. When the query reformulations fail to properly capture the intent of the search, the user typically enters subsequent queries until relevant item listings are found.

These repetitive inputs in conventional item retrieval systems for listing platforms result in increased computing resource consumption, among other things. For instance, repetitive search queries result in packet generation costs that adversely affect computer network communications. Each time a user issues a query, the contents or payload of the query is typically supplemented with header information or other metadata within a packet in TCP/IP and other protocols. Accordingly, when this functionality is multiplied by all the inputs needed to obtain the desired data, there are throughput and latency costs by repetitively generating this metadata and sending it over a computer network. In some instances, these repetitive inputs (e.g., repetitive clicks, selections, or queries) increase storage device I/O (e.g., excess physical read/write head movements on non-volatile disk) because each time a user inputs unnecessary information, such as inputting several queries, the computing system often has to reach out to the storage device to perform a read or write operation, which is time consuming, error prone, and can eventually wear on components, such as a read/write head. Further, if users repetitively issue queries, it is expensive because processing queries consumes a lot of computing resources. For example, for some item retrieval systems, a query execution plan may need to be calculated each time a query is issued, which could require a system to find the least expensive query execution plan to fully execute the query. This decreases throughput and increases network latency, and can waste valuable time.

Aspects of the technology described herein improve the functioning of server systems for listing platforms by providing improved query reformulation that matches intent of the searches. The improved query reformulation is provided by training a generative model to generate query reformulations for search queries based on the intent of each search query. The system can employ a set of predefined search intents for training the generative model and at inference time when the trained generative model is used to generate query reformulations for input search queries.

In accordance with some aspects, training data is gathered by accessing user behavior data, which includes sequences of search queries received during various user sessions. The user behavior data also includes information about user interactions with item listings identified in search results for each search query. Query pairs are identified from this data, including in-session query pairs from the same session and cross-session query pairs from different sessions. These query pairs serve as proxies for query reformulations for model training. Each query pair is then labeled with a search intent label based on identifying a predefined search intent for each query pair. Each labeled query pair provides a training sample that includes a source query, a target query, and a search intent label

The training dataset is used to train the generative model. During training, the model parameters are updated based on the training samples. The process can involve, for instance, providing a source query and search intent label from a training sample to the generative model, generating an output query, and calculating a loss based on the difference between the output query and the target query from the training sample. The model parameters are adjusted to minimize this loss, ensuring that the generative model can accurately generate reformulated queries based on intent.

Once trained, the generative model is used to perform query reformulation for input search queries. When a search query is received, the context of the search query is determined, which can be based on the user's current session history and/or the search application. Based on this context, a search intent is selected from the predefined set of search intents. The search query and the selected search intent are provided to the trained generative model, which generates a reformulated query. This reformulated query can then be used for various search operations, such as providing query suggestions or retrieving search results, thereby enhancing the relevance and accuracy of the search outcomes.

Aspects of the technology described herein provide a number of improvements over conventional query reformulation approaches used by existing item retrieval systems for listing platforms. For example, the technology leverages synergy between intent understanding and query reformulation, creating a versatile framework that addresses challenges across various scenarios. By integrating these strategies into item retrieval systems for listing platforms, this provides a robust, AI-driven solution that enhances the search experience, boosts recall and relevance, and drives improved outcomes.

This technology enables intent-specific reformulation strategies tailored to the user's journey and goals. This granularity allows the generative model to deliver targeted improvements, such as, for instance, optimizing recall for under-performing queries (e.g., null/low recall) while simultaneously driving discovery through inspired recommendations, providing a versatile solution that adapts to diverse search scenarios.

Additionally, by leveraging transactional, co-clicked, and two-hop neighbor data to form query pairs, the generative model in some aspects learns to predict user-centric query reformulations rooted in real-world interactions. This approach surpasses traditional heuristic-based data generation by grounding query reformulations in actual user engagement patterns, ensuring higher relevance and effectiveness of the model outputs.

Further, the technology described herein ensures broad coverage across a wide range of search scenarios, from intent preservation to intent diversification and inspiration. The multi-modal focus on recall optimization and recommendation-like behavior positions this technology as a comprehensive solution, bridging the gap between intent preservation and intent diversification.

As such, the technology described herein improves the ability of item retrieval systems to return search results relevant to the search intent. This improves both the precision and recall of item listings for the listing platform relative to conventional approaches. Among other things, this provides for improved computing resource consumption for server systems of listing platforms relative to existing item retrieval technologies. For instance, the ability of the item retrieval system to match query reformulations to search intent using aspects of the technology described herein provides improved search result relevance, which eliminates (or at least reduces) the repetitive search queries, search result selections, and rendering of item listings relative to conventional techniques because relevant item listings are provided without the need for users to continuously input various search queries to access search results and/or continuously make item selections to obtain further information around presented item listings. Accordingly, aspects of the technology described herein decrease computing resource consumption, such as packet generation costs. For instance, a search query (e.g., an HTTP request), would only need to traverse a computer network once (or fewer times relative to existing technologies). Specifically, the contents or payload of the search query is supplemented with header information or other metadata within a packet in TCP/IP and other protocols once for the initial search query. Such packet for a search query is only sent over the network once or fewer times. Thus, there is no repetitive generation of metadata and continuous sending of packets over a computer network.

In like manner, aspects of the technology described herein improve storage device or disk I/O and query execution functionality, as they only need to go out to disk a single time (or fewer times relative to existing item retrieval technologies). As described above, the inadequacy of existing query reformulation technologies results in repetitive search queries, search result selections, and item listing renderings. This causes multiple traversals to disk. In contrast, aspects described herein reduce storage device I/O because the computing system receives fewer inputs and so the computing system does not have to reach out to the storage device as often to perform a read or write operation. Accordingly, there is not as much wear on components, such as a read/write head, because disk I/O is substantially reduced.

### Example System for Intent-Centric Search Query Reformulation

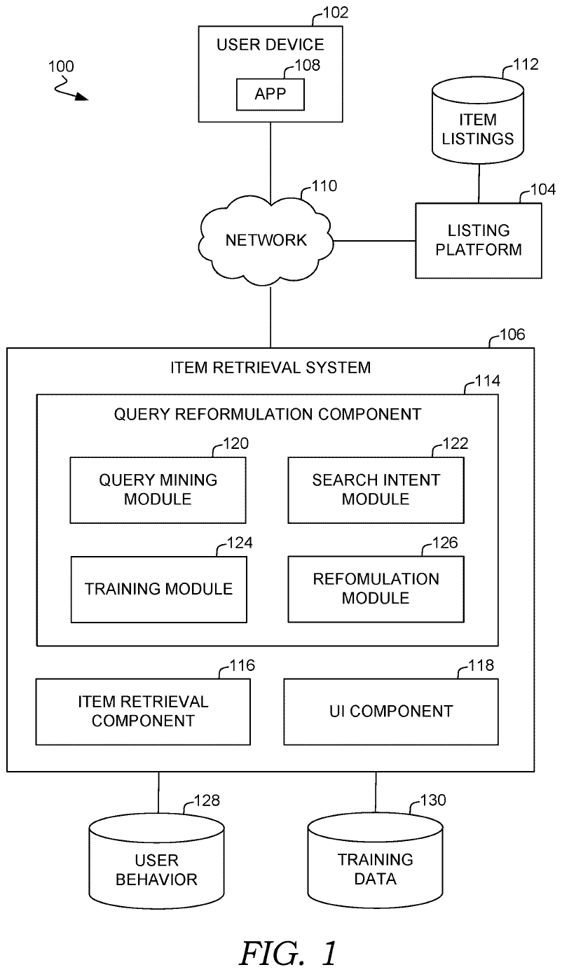

With reference now to the drawings, FIG. 1 is a block diagram illustrating an exemplary system 100 for training and employing a generative model to perform query reformulations based on search intents in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

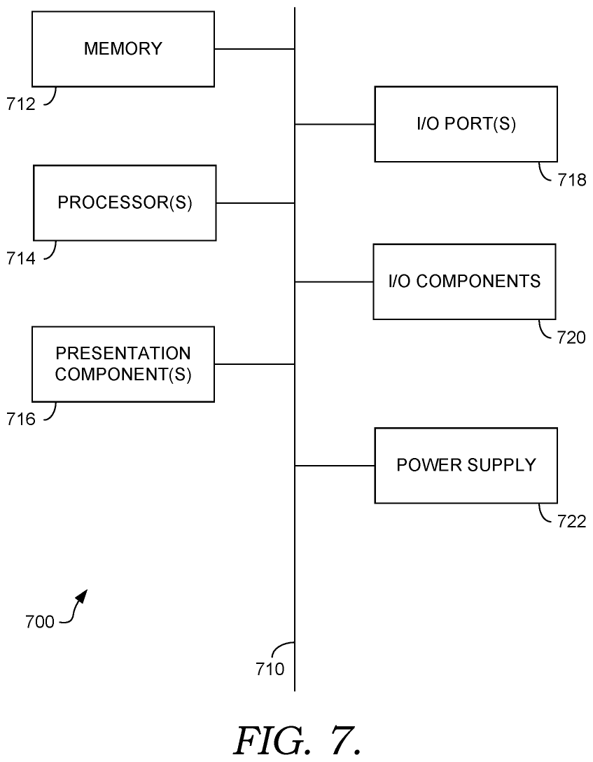

The system 100 is an example of a suitable architecture for implementing certain aspects of the present disclosure. Among other components not shown, the system 100 includes a user device 102, a listing platform 104, and an item retrieval system 106. Each of the user device 102, the listing platform 104, and the item retrieval system 106 shown in FIG. 1 can comprise one or more computer devices, such as the computing device 700 of FIG. 7, discussed below. As shown in FIG. 1, the user device 102, the listing platform 104, and the item retrieval system 106 can communicate via a network 110, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the listing platform 104 and the item retrieval system 106 could each be provided by multiple server devices collectively providing the functionality of the listing platform 104 and the item retrieval system 106 as described herein. Additionally, other components not shown may also be included within the network environment.

The user device 102 can be a client device on the client-side of the system 100, while the listing platform 104 and the item retrieval system 106 can be on the server-side of the system 100. The listing platform 104 and/or the item retrieval system 106 can each comprise server-side software designed to work in conjunction with client-side software on the user device 102 so as to implement any combination of the features and functionalities discussed in the present disclosure. For instance, the user device 102 can include an application 108 for interacting with the listing platform 104 and/or the item retrieval system 106. The application 108 can be, for instance, a web browser or a dedicated application for providing functions, such as those described herein. This division of the system 100 is provided to illustrate one example of a suitable environment, and there is no requirement for each implementation that any combination of the listing platform 104 and the item retrieval system 106 remain as separate entities. For instance, in some aspects, the item retrieval system 106 is a part of the listing platform 104. While the system 100 illustrates a configuration in a networked environment with a separate user device, listing platform, and item retrieval system, it should be understood that other configurations can be employed in which aspects of the various components are combined.

The user device 102 may comprise any type of computing device capable of use by a user. For example, in one aspect, a user device may be the type of computing device 700 described in relation to FIG. 7 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the user device 102 and may interact with the listing platform 104 and/or the item retrieval system 106 via the user device 102.

The listing platform 104 can be implemented using one or more server devices, one or more platforms with corresponding application programming interfaces, cloud infrastructure, and the like. The listing platform 104 generally provides, to user devices such as the user device 102, item listings describing items (physical or digital) available for purchase, rent, streaming, download, etc. For instance, the listing platform 104 could comprise an e-commerce platform, in which listed products or services are available for purchase by users of the user device 102 upon navigation to the listing platform 104.

The functionality of the listing platform 104 includes provision of interfaces enabling surfacing of item listings for items to users of the listing platform 104. Item data for item listings available via the listing platform 104 are stored by the item listings data store 112. The item data for each item listing may include, for instance, information relating to an item comprising one or more of: an item title, an item description, a category, a price in a currency, reviews, images of the item, shipment options, a rating, a condition of the item, a size of the item, a color of the item, etc. The item data can include structured data (attribute name-attribute value pairs) and unstructured text. In some aspects, each item listing is also associated with one or more categories from a category hierarchy for the listing platform 104 (e.g., using category identifiers), including meta-categories and leaf categories. For example, the meta-categories are each divisible into subcategories (or branch categories), whereas leaf categories are not divisible.

The item retrieval system 106 facilitates item retrieval for the listing platform 104, including providing search operations that return query suggestions and/or search results identifying item listings in response to search queries. In accordance with aspects of the technology described herein, the item retrieval system 106 trains a generative model to perform intent-based query reformulations. The item retrieval system 106 also uses the trained generative model to generate query reformulations for input search queries and employs the query reformulations in downstream search operations.

As shown in FIG. 1, the item retrieval system 106 includes a query reformulation component 114, an item retrieval component 116, and a user interface component 118. The components/modules of the item retrieval system 106 may be in addition to other components/modules that provide further additional functions beyond the features described herein. The item retrieval system 106 can be implemented using one or more server devices, one or more platforms with corresponding application programming interfaces, cloud infrastructure, and the like. While the item retrieval system 106 is shown separate from the listing platform 104 and the user device 102 in the configuration of FIG. 1, it should be understood that in other configurations, some of the functions of the item retrieval system 106 can be provided on the listing platform 104 and/or the user device 102. Additionally, while the components/modules are shown as part of the item retrieval system 106, in other configurations, one or more of the components and/or modules thereof can be provided by the listing platform 104 or another location not shown in FIG. 1. The components/modules can be provided by a single entity or multiple entities.

In some aspects, the functions performed by components/modules of the item retrieval system 106 are associated with one or more applications, services, or routines. In particular, such applications, services, or routines may operate on one or more user devices, servers, may be distributed across one or more user devices and servers, or be implemented in the cloud. Moreover, in some aspects, these components/modules of the item retrieval system 106 may be distributed across a network, including one or more servers and client devices, in the cloud, and/or may reside on a user device. Moreover, these components/modules, functions performed by these components/modules, or services carried out by these components/modules may be implemented at appropriate abstraction layer(s) such as the operating system layer, application layer, hardware layer, etc., of the computing system(s). Alternatively, or in addition, the functionality of these components/modules and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components/modules shown in example system 100, it is contemplated that in some aspects, functionality of these components/modules can be shared or distributed across other components/modules.

The query reformulation component 114 of the item retrieval system 106 trains a generative model for query reformulation based on search intents and employs the trained generative model for performing query reformulations of search queries from user devices, such as the user device 102. As shown in FIG. 1, the query reformulation component 114 comprises a query mining module 120, a search intent module 122, a training module 124, and a reformulation module 126. As discussed in further detail below, the query mining module 120, the search intent module 122, and the training module 124 collectively provide operations to train a generative model. Once the generative model is trained, the reformulation module 126 employs the trained generative model to generate reformulated queries from input search queries

The query mining module 120 identifies query pairs from user behavior data stored in a user behavior data store 128. The user behavior data in the user behavior data store 128 can include, for instance, information regarding search queries submitted by users to the item retrieval system 106 for identifying item listings on the listing platform 104. The user behavior data can be organized by user session, in which the search queries submitted by a user in a given user session are stored as session data in the order in which the search queries were received. For instance, session data for a given user session can include a series of search queries in the order in which each search query was received during the user session.

The user behavior data can also include information regarding user interactions with item listings identified in search results for each search query. For instance, for a given search query, the user behavior data can store an indication of item listings with which the user interacted (if any). In some instances, the user behavior data can also store information identifying a type of user interaction for each of those item listings, such as clicked (e.g., search result selected on search results page), added to cart, added to wish list, purchased, etc.

The query pairs are identified by the query mining module 120 as proxies of query reformulations for model training purposes. For instance, one search query from a query pair can serve as a source query while the other search query from the query pair can serve as a target query, where the source query can be viewed as an input search query and the target query can be viewed as a reformulated query for the source query. In some instances, a target query is a search query in the user behavior data that resulted in a successful user interaction with one or more item listings (e.g., click, add to cart, add to wish list, purchase, etc.) and a source query is a search query that preceded the target query, either in the same session or across sessions, as described in further detail below.

In some aspects, the query mining module 120 identifies query pairs from in-session data for a single session, which are referred to herein as in-session query pairs. In-session query pairs focus on a single user's intent during a user session while optimizing recall or aligning it with available item listings. An in-session query pair comprises two queries within a same session where a previous query in the session is treated as a source query that transitions to a subsequent query in the user session that is treated as a target query. In some instances, the target query is a search query that led to a successful user interaction (e.g., click, add to cart, add to wish list, purchase, etc.). The type of user interaction used can be configurable. For instance, in some cases, the query mining module 120 could be configured to only identify search queries as target queries when the search queries resulted in a purchase.

In various configurations, different numbers of hops can be employed for identifying query pairs from in-session data. For instance, in some cases, the query pairs are limited to 1-hop query pairs, which are consecutive search queries in a user session. As an example to illustrate, suppose a user submits a search query “iphone 15”, and then submits “iphone 16” as the next search query in that session. In that example, “iphone 15” serves as a source query and “iphone 16” serves as a target query. In some cases, the query pairs can be n-hop query pairs where n is a configuration setting to allow for a certain number n of hops between search queries in session data for a user session to capture non-adjacent search queries as query pairs. As an example to illustrate, suppose a system is configured to use up to 2-hop query pairs, and a user session includes the following sequence of search queries: “iphone”; “iphone 15”, and “iphone 16”. In that example, the query pairs can include: [iphone, iphone 15](1-hop query pair); [iphone; iphone 16](2-hop query pair); and [iphone 15, iphone 16](1-hop query).

Forming only in-session query pairs can result in contextual bias, where the user for a given user session might overlook several contextual factors for reformulation caused by focusing on the previous search queries and item listings viewed. To address this bias in some aspects, the query mining module 120 also identifies query pairs from cross-session data for two sessions, which are referred to herein as cross-session query pairs. This introduces some diversity while preserving a connection from one search query to another search query. Cross-session query pair formation can involve identifying pairs of search queries from different user sessions that resulted in user interaction (e.g., click, add to cart, add to wish list, purchase, etc.) on a threshold number of the same item listings. Both the type of user interaction and the threshold number of same item listings are configurable. This type of query pair is referred to herein as a co-engaged cross-session query pair. The threshold for the number of shared item listing user interactions can be adjusted, allowing the query mining module 120 to capture varying degrees of similarity between sessions.

By way of example to illustrate, suppose a first session included the search query “iphone 15” and a second session included the search query “iphone 16”, and both of those search queries resulted in user interaction with the same item listing. In that case, a query pair is formed from the two pairs. In this case, either search query could be treated as the source query or the target query. As such, in some cases, two query pairs can be formed (e.g., [iphone 15, iphone 16]; and [iphone 16, iphone 15]).

In some aspects, the query mining module 120 can also identify query pairs using neighboring search queries within cross-session data, referred to herein as n-hop cross-session query pairs. This involves forming cross-session query pairs with search queries that are a certain number n of hops from a search query included in a co-engaged cross-session query pair. For instance, if two search queries from different sessions resulted in user interaction with the same item listing (i.e., co-engaged cross-session query pair), the query mining module 120 can also form n-hop cross-session query pairs from the search queries before and/or after the search queries in the co-engaged cross-session query pair from each user session. This helps in capturing a broader context of user behavior and identifying additional relevant query pairs.

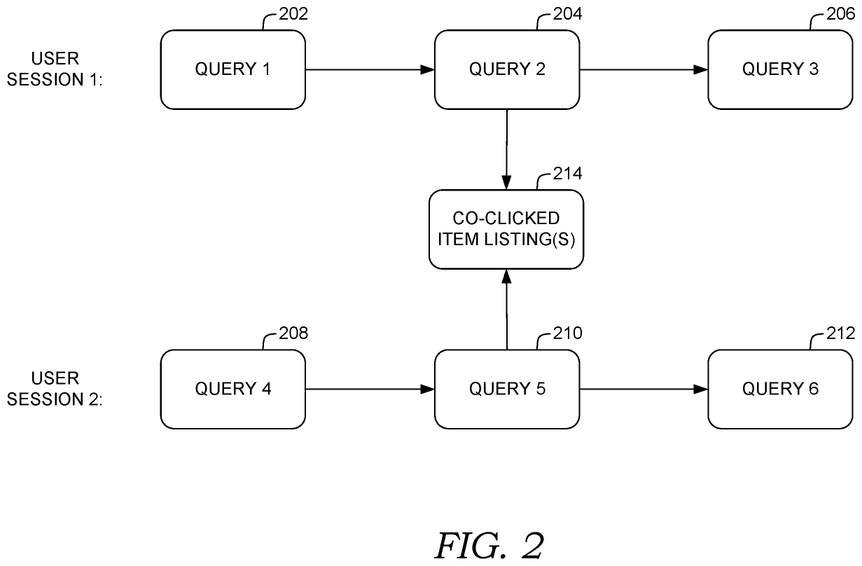

FIG. 2 provides a block diagram to illustrate examples of forming query pairs from user behavior data. In particular, FIG. 2 provides a simplified example that includes user behavior data for two user sessions. User session 1 includes the following sequence of search queries: query 202, query 204, and query 206. User session 2 includes the following sequence of search queries: query 208, query 210, and query 212. Additionally, query 204 from user session 1 and query 210 from user session 2 both resulted in one or more co-clicked item listings 214.

For in-session query pairs, from user session 1, the system could identify [query 202, query 204] and [query 204, query 206] as 1-hop in-session query pairs, and could also identify [query 202, query 206] as a 2-hop in-session query pair. From user session 2, the system could identify [query 208, query 210] and [query 210, query 212] as 1-hop in-session query pairs, and could also identify [query 208, query 212] as a 2-hop in-session query pair.

For cross-session query pairs from the two user sessions, the system could identify [query 204, query 210] and/or [query 210, query 204] as a co-engaged cross-session query pair based on the co-clicked item listing(s) 214 for those two search queries. The system could also identify the following as 1-hop cross-session query pairs: [query 202, query 210]; [query 208, query 204]; [query 204, query 212]; [query 210, query 206]. The system could further identify the following as 2-hop cross-session query pairs: [query 202, query 212]; and [query 208, query 206].

With reference again to FIG. 1, the search intent module 122 of the query reformulation component 114 determines a search intent for each query pair identified by the query mining module 120 and assigns a corresponding search intent label to each query pair. The number and types of search intents used by the query reformulation component 114 is configurable. By way of example only and not limitation, in some configurations, three types of search intents are used: same intent, similar intent, and inspired intent. Examples of query pairs for these three types of search intents are provided below in Table 1.

TABLE 1
Query Pair Examples for Different Use Intents

| Search | | |
|---|---|---|
| intent | Source Query | Target Query |
| Same | nike air jordan 4 | nike air jordan 11 |
| Intent | iphone 11 unlocked | iphone 14 unlocked |
| | maga hat official | maga hat authentic |
| Similar | nike womens size 9 | nike womens air max size 9 |
| Intent | iphone 14 plus case | phone case with stand |
| Inspired | samsung flip | iphone 14 |
| Intent | adidas adios pro 4 | nike ultrafly trail 12 |

The “same intent” captures query pairs with high similarity. For instance, in Table 1, “nike air jordan 4” and “nike air jordan 11” are an example query pair for this type of search intent. In that example, the only difference between the two search queries is that the aspect model version is modified from “4” in the source query to “11” in the target query. The “similar intent” is intended to capture queries with specificity changes. For instance, in Table 1, “nike womens size 9” and “nike womens air max size 9” are an example query pair for this type of search intent. In this example, the target query has an additional aspect (“air max”) specified, which makes the target query more specific than the source query. The specificity of source query is broader, whereas the target query is narrower. The “inspired intent” captures search queries with low similarity but acts as a pivot which motivates the user for relevant items.

It should be noted that the “same intent”, “similar intent”, and “inspired intent” are provided by way of example only and a variety of alternative search intents can be employed depending on the use case. For instance, the search intents could be based search intents, such as “transactional intent”, “navigational intent”, or “informational intent”. “Transactional intent” refers to searches conducted with the intention of completing a specific transaction, such as making a purchase, signing up for a service, downloading something, or any other action that involves some form of interaction or exchange. “Navigational intent” refers to searches aimed at finding a specific item or page. The user already knows the destination but uses search to get there. “Informational intent” refers to searches used when the user is looking for information rather than intending to perform a transaction or find a particular item or page. Other example search intents include, for instance: “comparative intent” when a user is searching for similar items to compare the items (e.g., two different makes/models of mobile devices); and “complementary intent” when a user is searching for complimentary items (e.g., a case for a mobile device).

The determination of search intents and labeling of query pairs can be performed either manually (e.g., by domain experts) or automatically, for instance, using predefined rules (e.g., heuristic rules). When done manually, experts can review the query pairs and assign a search intent label to each query pair based on their understanding of the search intent associated with each query pair. In automatic labeling, the search intent module 122 employs rules and/or machine learning models that consider any number of different factors to determine the search intents for query pairs in order to label the query pairs.

One factor that can be used by the search intent module 122 to determine the search intent for a query pair is the session type of the query pair, distinguishing between in-session and cross-session query pairs. The search intent module 122 can also consider the number of hops between the search queries in the session data. For example, queries that are adjacent may indicate a more direct refinement of search intent compared to those that are several hops apart.

The search intent module 122 can also use category matching between the search queries of a query pair to determine a search intent. Each search query can be assigned one or more categories from the category hierarchy for the listing platform 104 (e.g., query categorization), and the search intent module 122 can compare the categories of the two search queries from a query pair. In some cases, the comparison can be based on the categories relationship in the category hierarchy. For instance, search queries in the same category can be indicative of having a same or similar search intent, while search queries in different categories under the same parent category could be indicative of having a relatively less similar search intent. In some cases, the categories themselves can be evaluated to determine a search intent. For instance, the categories of two queries from a query pair could indicate a complementary relationship between the two search queries (e.g., one search query being categorized in an item category, such as mobile device; and the other query being categorized in an accessory category, such as a mobile device case).

The search intent module 122 can also consider similarity between the search queries of a query pair when determining a search intent. This could include character-level similarity matching, where the characters in the search queries are compared to determine their similarity. For example, the queries “iphone 15” and “iphone 16” differ by only one character, suggesting a high similarity. Query length matching between two queries of a query pair can also be performed by comparing the number of characters, words, or token in the search queries. The search intent module 122 can also use recall matching as a factor, which refers to the overlap of item listings retrieved for the two search queries in the query pair. Embedding-level similarity matching is another technique that can be used, where embedding models are used to generate embedding vectors for each search query from a query pair and a distance between these embedding vectors (e.g., cosine similarity) is used to assess similarity between the two search queries. In still further configurations, the search intent module 122 can consider a sequence of search queries from a session to determine the search intent for a query pair from that sequence. In other words, search queries in the sequence that are not included in the query pair can be considered.

Query pairs identified by the query mining module 120 and labeled with search intent labels by the search intent module 122 are stored as a training dataset in a training data store 130. The training dataset comprises training samples in which each training sample comprises a labeled query pair—i.e., a source query, a target query, and a search intent label.

The training module 124 employs the training dataset from the training data store 130 to train a generative model for query reformulation. The generative model can comprise, for instance, a language model that includes a set of statistical or probabilistic functions to perform natural language processing (NLP) in order to understand, learn, and/or generate human natural language text. For example, a language model can be a tool that determines the probability of a given sequence of words occurring in a sentence or other natural language sequence. A language model is called a large language model (LLM) when it is trained on enormous amount of data and/or has a large number of parameters. Some examples of LLMs are GOOGLE's BERT and OpenAI's GPT-4. These models have capabilities ranging from writing a simple essay to generating complex computer codes—all with limited to no supervision. Accordingly, an LLM can comprise a deep neural network that is very large (e.g., billions to hundreds of billions of parameters) and understands, processes, and produces human natural language and code by being trained on massive amounts of text. These models can predict future words in a sequence letting them, for instance, generate sentences similar to how humans talk and write or otherwise in a form dictated, for instance, by a prompt.

In accordance with some aspects, the generative model comprises a neural network (i.e., an artificial neural network). As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

The generative model can use a variety of different network architectures. By way of example only and not limitation, the generative model could comprise an encoder-decoder architecture. In some cases, the generative model can have a decoder for each search intent. For instance, if three search intents are used, the generative model could be constructed to include three decoders—one for each of the three search intents. In some aspects, the model architecture of the generative model is built and trained from scratch; while in other aspects, one or more pre-trained models are selected, configured, and fine-tuned. The generative model can be initialized by setting initial values for model parameters (e.g., weights), selecting loss function(s) for training, and setting hyperparameters for training the model, such as, for instance, regularization parameters, model parameters (e.g., a number of layers in a neural network), learning rate, batch sizes selected from the training data, and so on.

After model initialization, the training module 124 trains the generative model using training samples from the training dataset in the training data store 130. During model training, parameters (e.g., weights) associated with each neuron in the generative model can be updated. The initialized generative model can comprise random parameter values or pre-trained parameters values that are adjusted during training. In one aspect, the generative model is trained using backpropagation. The backpropagation process comprises a forward pass, a loss function, a backward pass, and a parameter update. For instance, a forward pass could comprise providing a source query and a search intent label from a training sample to the generative model, which generates an output query. A loss could then be determined, for instance, as a function of the output query and the target query from the training sample (serving as ground truth for the training sample). Parameters (e.g., weights) of the generative model are updated based on the loss. This process is repeated using the training data. The goal is to update the parameters of each neuron (or other model component) to cause the generative model to produce useful output. Once trained, the weight associated with a given neuron can remain fixed. The other data passing between neurons can change in response to a given input. Retraining the network with additional training data can update one or more parameters in one or more neurons.

In some aspects, the training module 124 optimizes the generative model using any of a number of different techniques, such as pruning, quantization, knowledge distillation, and low-rank adaptation (LoRA). Implementing these techniques can make the generative model more efficient to reduce computer resource requirements and latency without significantly impacting performance. In some aspects, the generative model is optimized by fine-tuning a smaller pre-trained model intended for environments with restricted computational resources.

Once the generative model has been trained, the reformulation module 126 employs the trained generative model to provide reformulated queries for search queries received from user devices, such as the user device 102. When a search query is received, the reformulation module 126 determines a context of the search query. This context can be derived from various factors, including the search application of the search query, such as whether it is for natural language retrieval, organized retrieval, paid search results, organic search results, related searches, addressing low inventory or null/low recall situations, providing suggested queries, powering merchandising or advertising use cases, organizing search result pages using horizontal carousels for structured recovery, or other downstream applications. Additionally or alternatively, the context can be informed by the current session's history, such as by analyzing the sequence of search queries previously submitted by the user within the current session and/or item listings with which the user interacted in response to those search queries. This information from the current session can be used to understand the user's intent better in order to select a search intent for the search query from a set of predefined search intents.

The reformulation module 126 selects a search intent from the predefined set of search intents based on the context of the search query. The selection of the search intent is based on the determined context to ensure that the reformulated query aligns with the user's needs and/or the search application's requirements. In some aspects, the reformulation module 126 uses rules that map context of search queries to the different search intents. For instance, if the context indicates that the search query is for improving recall in search results, the reformulation module 126 could select the same intent or similar intent. Conversely, if the context is for advertisement purposes, the reformulation module 126 could select the similar intent or inspired intent. In further aspects, the reformulation module 126 could employ a machine learning model to select a search intent based on a context for a search query. For instance, the machine learning model could be a classifier model that is trained on training data in which each training sample comprises context information pair with search intent labels (as ground truth). Using such training data, the machine learning model learns to accurately predict search intent labels based on context information.

After determining a search intent for a received search query, the reformulation module 126 provides the search query along with the selected search intent to the trained generative model. The generative model, which has been trained by the training module 124 on query pairs with search intent labels, uses this information to generate a reformulated query. The generative model's training allows it to understand the nuances of different search intents and produce reformulated queries that are contextually appropriate and relevant to the user's original query.

Reformulated queries from the reformulation module 126 can be employed for a variety of search operations. By way of example only and not limitation, reformulated queries can be provided to users as query suggestions. Query suggestions are recommendations provided by item retrieval systems to help users refine and optimize their search queries for better results. In such configurations, reformulated queries could be returned as query suggestions in a number of different ways, such as, for instance, as completion options while the user enters the search query and/or on search result pages with search results selected using the original search queries.

In other aspects, reformulated queries can be used to select and return search results. In the context of FIG. 1, the item retrieval component 116 of the item retrieval system 106 receives reformulated queries from the reformulation module 126 and uses the reformulated queries to select item listings from the item listings data store 112 of the listing platform 104 and return search results based on the selected item listings.

Upon receiving the reformulated queries, the item retrieval component 116 initiates a search process that can involve any of a number of different techniques to ensure relevant and accurate search results are returned. For instance, the item retrieval system 106 can employ a reformulated query to perform a recall operation, which involves identifying certain item listings as potential matches based on the reformulated query. This process provides a broad set of relevant item listings that are further considered in downstream processes. For instance, following the recall operation, the item retrieval component 116 can employ any number of ranking algorithms to prioritize the identified item listings. These algorithms can assess various factors such as relevance, popularity, and user feedback to rank the item listings in order of their likelihood based on the reformulated query. The highest-ranked item listings are then selected and compiled into a list of search results. It should be noted that the above description is intended only to provide an example of search operations that can be performed by the item retrieval component 116, and a variety of other search operations can be employed in addition to or in lieu of those described above.

The item retrieval system 106 further includes a user interface component 118 that provides one or more user interfaces for interacting with the listing platform 104 and/or the item retrieval system 106. While shown as part of the item retrieval system 106 in FIG. 1, in some configurations, the user interface component 118 can be part of the listing platform 104. The user interface component 118 provides one or more user interfaces to a user device, such as the user device 102. In some instances, the user interfaces can be presented on the user device 102 via the application 108, which can be a web browser or a dedicated application for interacting with the listing platform 104 and/or the item retrieval system 106. For instance, the user interface component 118 can provide user interfaces for, among other things, allowing users to enter search queries or otherwise navigate the listing platform 104. The user interfaces can further provide query suggestions based on reformulated queries and/or search results identifying item listings selected by the item retrieval system 106 using reformulated queries.

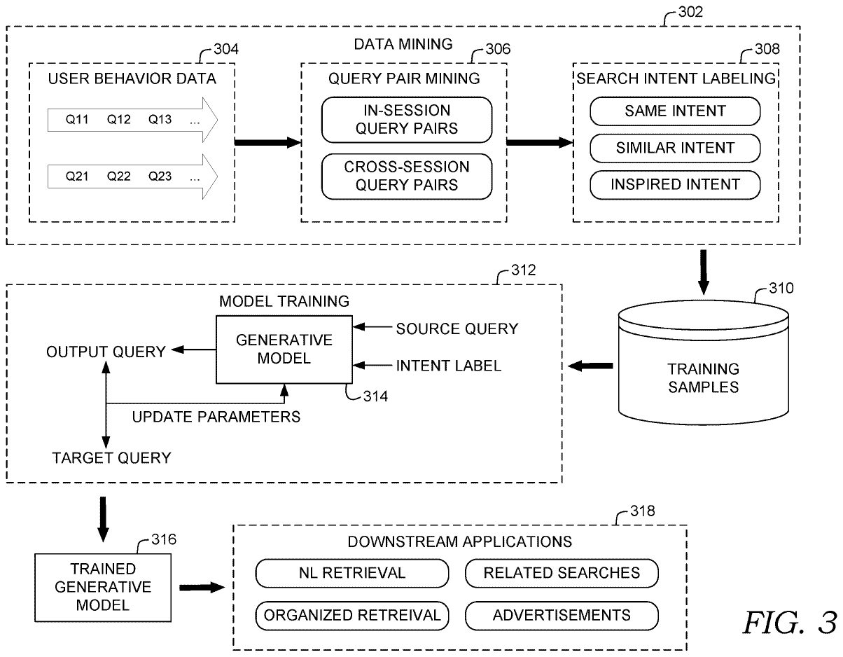

Turning next to FIG. 3, a block diagram is provided that illustrates an example overall operation for intent-centric query reformulation in accordance with some aspects of the technology described herein. As shown in FIG. 3, the operation begins with a data mining process 302. Initially, user behavior data 304 is accessed. The user behavior data 304 includes sequences of search queries received during each of a number of different user sessions. The user behavior data 304 also includes an indication of item listings with which a user interacted for each search query during each user session.

A query mining operation 306 analyzes the user behavior data 304 to identify query pairs. These query pairs are formed based on search queries within a single session (in-session query pairs) or across multiple sessions (cross-session query pairs). Each query pair includes a source query and a target query. A search intent labeling operation 308 obtains a search intent label for each query pair. In some aspects, the query pairs are manually labeled, for instance, by domain experts; while in other aspects, the query pairs are automatically labeled based on different factors, as described hereinabove. FIG. 3 provides an example showing three different search intents (“same intent”, “similar intent”, and “inspired intent”). However, as previously noted, the type of search intents used are configurable.

Training samples are generated and stored in a training data store 310. Each training sample comprises a labeled query pair—i.e., a source query, a target query, and a use intent label. The training samples are then used to train a generative model 314 during a model training operation 312. The model training operation 312 for a given training sample can include, for instance, providing a source query and search intent from the training sample as input to the generative model 314, which provides an output query. A loss is determined based on the output query and the target query from the training sample, and parameters of the generative model 314 are updated based on the loss (e.g., via backpropagation).

The model training operation 312 provides a trained generative model 316. The trained generative model 316 can be used to perform query reformulation for a variety of different downstream applications 318. FIG. 3 shows a number of different applications, including natural language retrieval, organized retrieval, related searches, and advertisements (paid search). However, it should be noted that these are provided by way of example only, and reformulated queries can be used in any of a number of different search applications. The process at this stage can include, receiving an input search query, determining a search intent for the input search query (which can be based on the application), and providing the input search query and the search intent to the trained generative model 316 to obtain a reformulated query. The reformulated query can then be used for various search operations, such as providing query suggestions and/or retrieving search results.

### Example Methods for Intent-Centric Search Query Reformulation

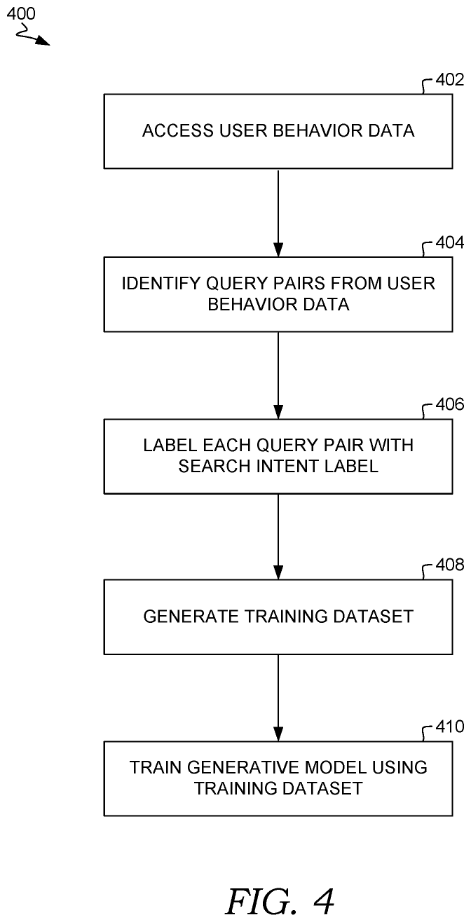

With reference now to FIG. 4, a flow diagram is provided that illustrates a method 400 for training a generative model for intent-centric search query reformulation in accordance with some aspects. The method 400 may be performed at least in part, for instance, by the query reformulation component 114 of FIG. 1. Each block of the method 400 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 402, user behavior data is accessed. The user behavior data includes sequences of search queries received during various user sessions. This data can be stored in a user behavior data store and can also include information about user interactions with item listings identified in search results for each search query. The user behavior data can be organized by user session, where each session includes a series of search queries in the order they were received. In some aspects, the user behavior data includes information about the type of user interactions with item listings, such as clicks, additions to cart, wish lists, and purchases.

Query pairs are identified from the user behavior data at block 404. These query pairs serve as proxies for query reformulations during model training. Some query pairs can be identified from in-session data, where query pairs are formed from queries within the same session (referred to as in-session query pairs). Some query pairs can be identified from cross-session data, where query pairs are formed from queries across different sessions. The in-session query pairs focus on a single user's intent during a session, while cross-session query pairs introduce diversity by connecting search queries from different sessions that resulted in interactions with the same item listings.

As shown at block 406, the query pairs are labeled with search intent labels. The search intent labels categorize the query pairs based on the nature of the queries, such as, for instance, “same intent,” “similar intent,” or “inspired intent.” The labeling can be done manually by domain experts or automatically using predefined rules or machine learning models. Factors considered in labeling include session type, the number of hops between queries, category matching, recall matching, query length, character-level similarity, and embedding-level similarity.

A training dataset is generated from the labeled query pairs, as shown at block 408. The training dataset includes training samples, where each training sample comprises a source query, a target query, and a search intent label. This training dataset can be stored in a training data store and serves as the foundation for training the generative model. The training dataset is designed to provide a comprehensive representation of search query reformulations, capturing various search intents and behaviors.

As shown at block 410, the generative model is trained using the training dataset. The generative model can be a language model, such as a neural network with an encoder-decoder architecture. During training, the model parameters are updated based on the training samples. The process can involve providing a source query and search intent label to the model, generating an output query, and calculating a loss based on the difference between the output query and the target query. The model parameters are adjusted to minimize this loss, ensuring that the model can accurately generate reformulated queries. The training process can also include optimization techniques such as pruning, quantization, knowledge distillation, and low-rank adaptation to enhance model efficiency.

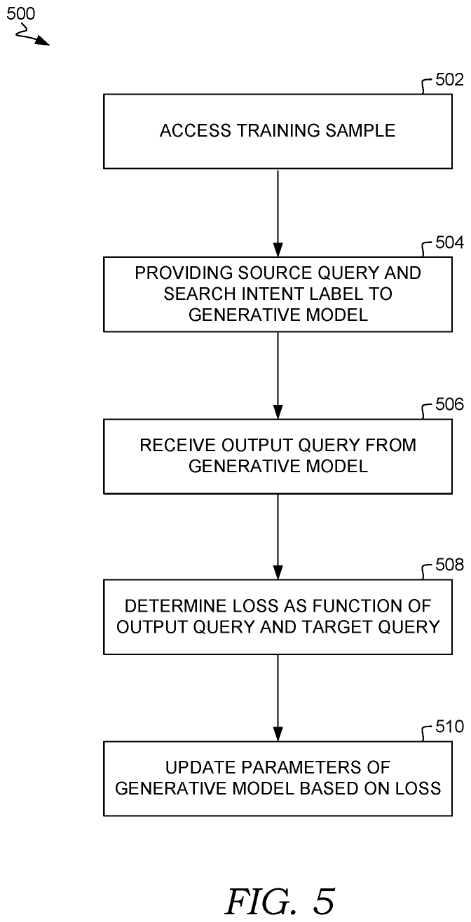

Turning next to FIG. 5, a flow diagram is provided showing another method 500 for training a generative model for intent-centric search query reformulation. The method 500 can be performed at least in part, for instance, by the training module 124 of FIG. 1. As shown at block 502, a training sample is accessed. This training sample includes a source query, a target query, and a search intent label (for instance, as generated in accordance with the method 400).

The source query and search intent label from the training sample are provided as input to the generative model, as shown at block 504. The generative model processes the source query and the search intent label in order to generate an output query, as shown at block 506. The output query is considered to be a reformulated query for the source query.

As shown at block 508, a loss is determined as a function of the output query and the target query from the training sample. The target query serves as the ground truth for the training sample, and the loss function can measure the difference between the output query generated by the generative model and the target query. The parameters of the generative model are then updated based on the loss, as shown at block 510. For instance, backpropagation can be used to adjust model parameters (e.g., weights and biases) based on the loss.

In some aspects, the model parameters are iteratively updated using the training samples to ensure that the generative model can accurately generate reformulated queries based on search intent. This can include, for instance, iteratively causing the generative model to generate an output query for each training sample by providing a source query and a search intent label from each training sample as input to the generative model, and updating the model parameters based on a loss determined from each output query. The goal of the training process is to minimize this loss to improve the generative model's performance. Optimization techniques such as pruning, quantization, knowledge distillation, and low-rank adaptation may also be employed to enhance the model's efficiency and reduce computational resource requirements.

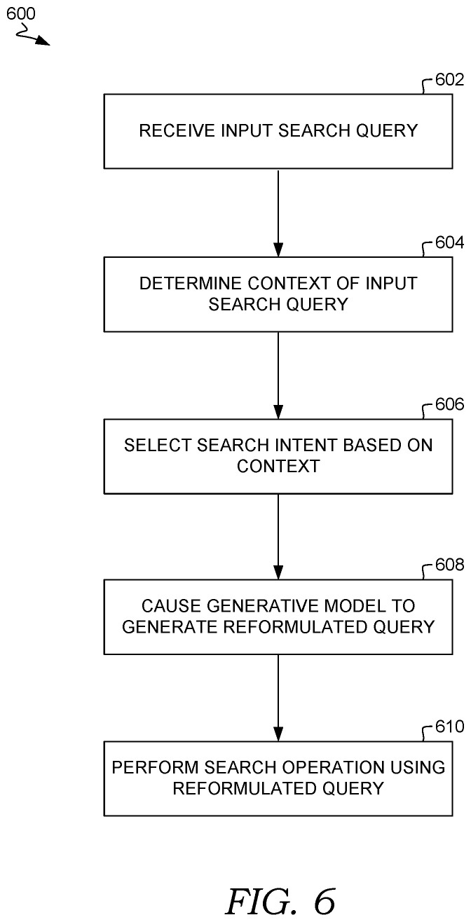

Turning next to FIG. 6, a flow diagram is provided showing a method 600 for obtaining a reformulated query and performing a search operation using the reformulated query. The method 600 can be performed at least in part, for instance, by the reformulation module 126 of FIG. 1. As shown at block 602, an input search query is received. For instance, the input search query can be entered by a user into an item retrieval system of a listing platform. The search query can be in the form of keywords, natural language, or any other input format supported by the item retrieval system.

A context of the input search query is determined at block 604. This can involve, for instance, analyzing various factors that provide insight into the user's intent and the environment in which the input search query was made. The context can include the user's current session history, previous queries, interactions with item listings, and other relevant data. Additionally, the context can be based on the application in which the input search query was made, such as whether it is for natural language retrieval, organized retrieval, or another search application.

As shown at block 606, the system selects a search intent for the input search query based on the determined context of the input search query. The search intent represents the underlying purpose or goal of the user's query. The system can use predefined rules or machine learning models to map the context to a specific search intent.

The input search query and search intent are provided to a trained generative model, causing the generative model to output a reformulated query for the input search query based on the search intent, as shown at block 608. The generative model, which has been trained on a dataset of labeled query pairs (e.g., via the methods 400 and 500), uses the input search query and search intent to produce the reformulated query.

As shown at block 610, a search operation is performed using the reformulated query. In some aspects, the search operation involves providing query suggestions for the input search query. In such aspects, the search operation involves providing the reformulated query as a query suggestion. In other aspects, the search operation involves returning search results using the reformulated query. For instance, the search operation can involve using the reformulated query to identify and/or rank item listings and provide a search results page with search results based on the item listings.

### Exemplary Operating Environment

Having described implementations of the present disclosure, an exemplary operating environment in which embodiments of the present technology may be implemented is described below in order to provide a general context for various aspects of the present disclosure. Referring initially to FIG. 7 in particular, an exemplary operating environment for implementing embodiments of the present technology is shown and designated generally as computing device 700. Computing device 700 is but one example of a suitable computing environment and is not intended to suggest any limitation as to the scope of use or functionality of the technology. Neither should the computing device 700 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 7 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc. The I/O components 720 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 700. The computing device 700 may be equipped with depth cameras, such as, stereoscopic camera systems, infrared camera systems, RGB camera systems, and combinations of these for gesture detection and recognition. Additionally, the computing device 700 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
accessing user behavior data comprising a plurality of search queries, each search query associated with a session comprising one or more search queries;
identifying a plurality of query pairs from the plurality of search queries, wherein the plurality of query pairs include a plurality of in-session query pairs from in-session data and a plurality of cross-session query pairs from cross-session data;
labeling the plurality of query pairs with search intent labels for a plurality of search intents;
generating a training dataset having a plurality of training samples, each training sample comprising a query pair from the plurality of query pairs and a search intent label from the search intent labels; and
training a generative model using the training dataset to provide a trained generative model that generates reformulated queries from input queries and search intents for the input queries.

2. The one or more computer storage media of claim 1, wherein the operations further comprise:
receiving an input search query entered by a user;
determining a context of the input search query;
selecting, from the plurality of search intents, a search intent based on the context of the input search query; and
generating a reformulated query for the input search query using the trained generative model and the selected search intent.

3. The one or more computer storage media of claim 2, wherein the operations further comprise:
selecting one or more search results using the reformulated query; and
providing the one or more search results for presentation by a user device of the user.

4. The one or more computer storage media of claim 2, wherein the operations further comprise:
providing the reformulated query as a query suggestion for presentation by a user device of the user.

5. The one or more computer storage media of claim 2, wherein the context of the input search query is determined based on one or more selected from the following: a search application of the input search query, and a session history of a current session in which the input search query was received.

6. The one or more computer storage media of claim 1, wherein the plurality of search intents comprise one or more selected from the following: a same intent, a similar intent, and an inspired intent.

7. The one or more computer storage media of claim 1, wherein labeling the plurality of query pairs with the search intent labels comprises:
determining, from the plurality of search intents, a search intent for each query pair based on one or more heuristic rules; and
assigning a selected search intent label to each query pair based on the search intent determined for each query pair.

8. The one or more computer storage media of claim 7, wherein the one or more heuristic rules applied to a first query pair from the plurality of query pairs are based on one or more selected from the following: a session-type of the first query pair; a number of hops between a first query and a second query of the first query pair; category matching between the first query and the second query of the first query pair; recall matching between the first query pair and the second query of the first query pair; query length matching between the first query and the second query of the first query pair; character-level similarity matching between the first query and the second query of the first query pair; and embedding-level similarity matching between the first query and the second query of the first query pair.

9. The one or more computer storage media of claim 1, wherein the generative model comprises an encoder-decoder architecture with a plurality of separate decoders for the plurality of search intents.

10. The one or more computer storage media of claim 1, wherein training the generative model using a first training sample comprising a first query pair and a first search intent label comprises:
providing a source query from the first query pair and the first search intent label to the generative model;
receiving an output query from the generative model based on the source query and the first search intent label; and
updating parameters of the generative model based on a loss determined as a function of the output query and a target query from the first query pair.

11. A computer-implemented method comprising:
receiving an input search query entered by a user;
determining a context of the input search query;
selecting, from a plurality of search intents, a search intent based on the context of the input search query;
causing a trained generative model to generate a reformulated query for the input search query based on the selected search intent; and
performing one or more search operations using the reformulated query.

12. The computer-implemented method of claim 11, wherein performing the one or more search operations using the reformulated query comprises:
selecting one or more search results using the reformulated query; and
providing the one or more search results for presentation by a user device of the user.

13. The computer-implemented method of claim 11, wherein performing the one or more search operations using the reformulated query comprises:
providing the reformulated query as a query suggestion for presentation by a user device of the user.

14. The computer-implemented method of claim 11, wherein the context of the input search query is determined based on one or more selected from the following: a search application of the input search query, and a session history of a current session in which the input search query was received.

15. The computer-implemented method of claim 11, wherein the trained generative model was provided by training a generative model by:
accessing a training dataset having a plurality of training samples, each training sample comprising a labeled query pair;
iteratively causing the generative model to generate an output query for each training sample by providing a source query and a search intent label from each training sample as input to the generative model; and
updating parameters of the generative model based on one or more losses determined as a function of the output query for each training sample and a target query from each training sample.

16. A computer system comprising:
one or more processors; and
one or more computer storage media storing computer-useable instructions that, when used by the one or more processors, cause the computer system to perform operations, the operations comprising:
generating a training dataset comprising a plurality of training samples of labeled query pairs by:
identifying a plurality of query pairs from user behavior data comprising sequences of search queries for a plurality of user sessions, and
labeling the plurality of query pairs with search intent labels for a plurality of search intents; and
training a generative model using the training dataset to provide a trained generative model by:
iteratively causing the generative model to generate an output query for each training sample by providing a source query and a search intent label from each training sample as input to the generative model, and
updating parameters of the generative model based on one or more losses determined as a function of the output query for each training sample and a target query from each training sample.

17. The computer system of claim 16, wherein the plurality of query pairs comprises at least one in-session query pair from a single user session and at least one cross-session query pair from two separate user sessions.

18. The computer system of claim 16, wherein a first query pair from the plurality of query pairs is labeled with a first search intent label based on one or more factors selected from the following: a session-type of the first query pair; a number of hops between search queries of the first query pair; category matching between search queries of the first query pair; recall matching between search queries of the first query pair; query length matching between search queries of the first query pair; character-level similarity matching between search queries of the first query pair; and embedding-level similarity matching between search queries of the first query pair.

19. The computer system of claim 16, wherein the operations further comprises:
receiving an input search query entered by a user;
determining a context of the input search query;
selecting, from the plurality of search intents, a search intent based on the context of the input search query;
generating a reformulated query for the input search query using the trained generative model and the selected search intent; and
performing one or more search operations using the reformulated query.

20. The computer system of claim 19, wherein the context of the input search query is determined based on one or more selected from the following: a search application of the input search query, and a session history of a current session in which the input search query was received.
